(19) United States
(12) Patent Application Publication
(10) Pub. No.: US 2005/0241199 A1
(43) Pub. Date: Nov. 3, 2005

(54) Ladder block

(76) Inventor: Arnold Bennett Ghormley, Pasadena, TX (US)

Correspondence Address: Arnold Bennett Ghormley, 2410 Sinclair Street, Pasadena, TX, 77503, US

(21) Appl. No.: 10/837,529

(22) Filed: May 3, 2004

(51) Int. Cl. G09F 7/22

(52) U.S. Cl. 40/617

(57) ABSTRACT

The LADDER BLOCK is an innovative engineering control device that when used properly will prohibit access to and use of incomplete or unsafe scaffolds and work platforms. The LADDER BLOCK should be used in conjunction with administrative controls and safety policy and procedures that provide the user with an additional method for the prevention of falls from elevations. The LADDER BLOCK offers the construction industry a ladder access prevention device that has heretofore been unavailable. This device will help reduce personal injury to workers and minimize direct and indirect costs to employers.

### BACKGROUND OF THE INVENTION

The invention, called the LADDER BLOCK, is relative to the construction industry where use and access to scaffolds and temporary work platforms with access ladders are used. Falls are the leading cause of injuries and fatalities in the construction industry. This LADDER BLOCK device blocks use and access to scaffolding or work platforms that are unsafe, incomplete or not authorized for use.

The only known document that references the need for the LADDER BLOCK is the Code of Federal Regulations, CFR 1926. The Occupational Safety and Health Administration, US Department of Labor, OSHA, has declared in the Code of Federal Regulations, CFR 1926.451(e)(9)(ii), that “Hook-on or attachable ladders shall be installed as soon as scaffold erection has progressed to a point that permits safe installation and use.” The LADDER BLOCK is attached to existing scaffold or access ladders to prevent users from ascending or descending until a competent person has inspected the scaffold levels above or below for safe use. (See description of the LADDER BLOCK).

Further, CFR 1926.451(f)(3), states that “Scaffolds and scaffold components shall be inspected for visible defects by a competent person before each work shift, and after any occurrence which could affect a scaffold's structural integrity”. The LADDER BLOCK device will minimize access and use of said scaffold until the competent person can inspect and declare the scaffold or work platform safe for use.

### BRIEF SUMMARY OF THE INVENTION

Employees in the construction industry are frequently exposed to unsafe and incomplete scaffolds and work platforms. Access to the scaffold work areas need to be blocked and use prohibited until the scaffold is complete and deemed safe for use by a competent person. Historically, colored tags and barricade tape attached to the access ladder have been used to indicate whether a scaffold or work platform is or is not complete for access and use. The universal problem in scaffold use is that tags and barricade tape do not provide a physical barrier to prevent access to an unsafe or incomplete scaffold. A device has been needed to physically block access to scaffolds and work platforms. Such a device is the LADDER BLOCK.

### BRIEF DESCRIPTION OF THE SEVERAL VIEWS OF THE DRAWING

FIG. 1 is frontal view depicting a scaffold ladder rungs and side rails in the background and the LADDER BLOCK attached by two “J” hooks placed over a ladder rung. The writing on the front surface: “Danger: Do Not Use Ladder”, provides a visual warning in addition to the physical barrier. The sizes listed are general due to the various dimensions of scaffold and access ladders.

FIG. 2 is a plan view or top view of the LADDER BLOCK depicting the physical barrier a user would encounter when descending a ladder. The writing on the top surface: “Danger: Do Not Climb Do Not Use”, serves as a visual warning in addition to the physical barrier.

FIG. 3 is a profile or right side view of the LADDER BLOCK depicting the “L” shape of the device, the “J” hooks, fasteners and a locking device (not a part of this invention). Typical sizes are listed on the figure.

FIG. 4 is a three-dimensional or isometric drawing of the LADDER BLOCK as it is attached to a scaffold ladder. Written warnings are printed on the two surfaces. A locking device holds the LADDER BLOCK to the scaffold ladder.

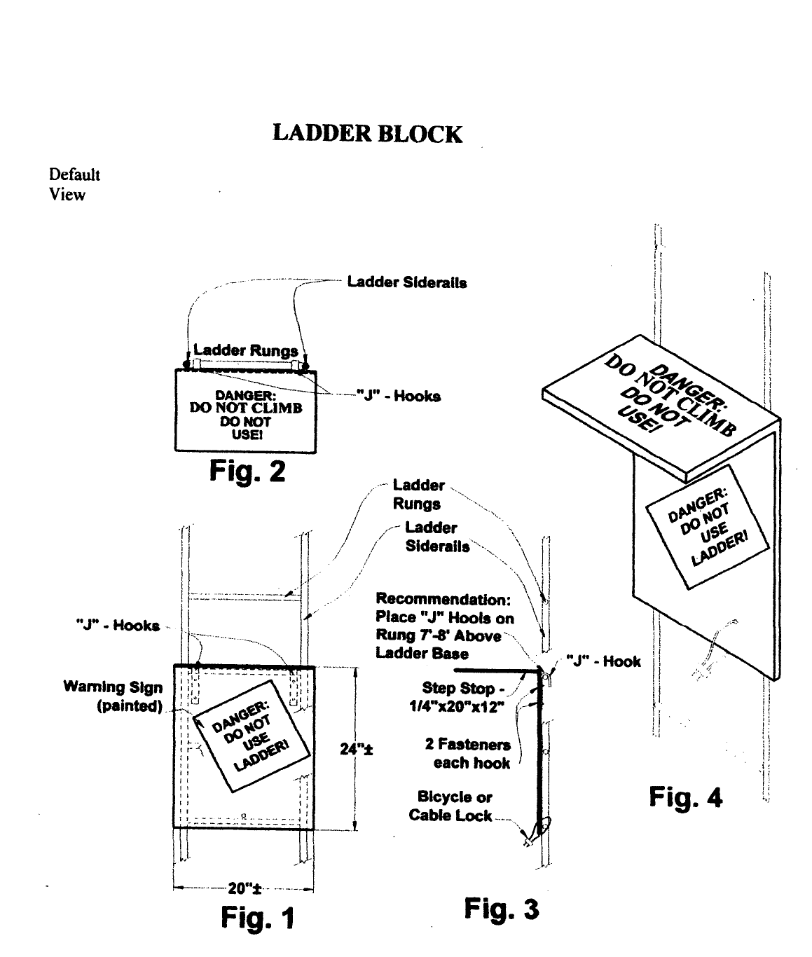

### DETAILED DESCRIPTION OF THE INVENTION

The ‘ladder block’ is an “L” shaped, break-resistant plastic device approximately ¼″×20″×24″ (vertical part) that attaches to the ladder and a horizontal part, ¼″×20″×12″, that is designed to prevent a ladder user from descending the ladder. The device is not intended for use on stepladders. The device is attached to existing scaffold ladders, fixed caged ladders, or other vertical ladders to prevent users from climbing the ladder, upward or downward, until a competent person has inspected the levels above or below for safe use. The principle of the device is to block three ladder rungs from use until the ‘ladder block’ is removed by the competent person after inspection, deeming the areas above or below as safe to access. Two “J” hooks are attached to the 20″×24″ part so that the device may be hung by the two “J” hooks over an upper ladder rung. The ‘ladder block’ is secured at the bottom by a bicycle lock or cable lock that protrudes through the plastic sheet and around a bottom ladder rung and locked in place. The lock prevents upward movement of the device preventing the “J” hooks from coming off the upper ladder rung. It is recommended that the “J” hooks be placed on a ladder rung approximately seven to eight feet above the base of the ladder. Warnings are printed on each surface: Danger: Do Not Use Ladder and Danger: Do Not Climb Do Not Use

1. The ladder block adapted as a physical barrier, comprising of:
a one-piece, two plane, L shaped sheet; components forming:
a vertical plane flush with ladder; and
a horizontal plane at 90 degrees to ladder; with attachment and securement.

2. Warning words printed on front of the vertical plane, described in claim 1: “Danger: Do Not Use Ladder”; warning words printed on top of the horizontal plane in claim 1: “Danger: Do Not Climb, Do Not Use”.

3. A ladder block as in claim 1 and claim 2 for replacing a standby person.
